(19) United States
(12) Patent Application Publication
(10) Pub. No.: US 2022/0007766 A1
(43) Pub. Date: Jan. 13, 2022

(54) CLOTHING LINE WITH ATTACHABLE POCKETS AND INTERCHANGEABLE PATCHES

(71) Applicant: MICHAEL MITCHELL, Yuba City, CA (US)

(72) Inventor: MICHAEL MITCHELL, Yuba City, CA (US)

(21) Appl. No.: 16/922,043

(22) Filed: Jul. 7, 2020

(51) Int. Cl. A41D 27/08; G09F 21/02; A41D 27/20

(52) U.S. Cl. CPC A41D 27/08; A41D 2400/70; A41D 27/20; G09F 21/02

(57) ABSTRACT

The clothing line with attachable pockets and interchangeable patches is a kit that includes a plurality of garments, one or more pocket structures, a plurality of patches, and a plurality of garment seams. Each garment seam selected from the plurality of garment seams attaches an individual pocket structure selected from the plurality of pocket structures to an individual garment selected from the plurality of garments. Each individual patch removably inserts into an individual pocket structure such that the image applied to the individual patch is visible through the individual pocket structure from the exterior of the individual garment. The clothing line with attachable pockets and interchangeable patches enables the image displayed on any individual patch to be readily moved and displayed from the first individual garment to any second individual garment selected from the plurality of garments.

### CROSS REFERENCES TO RELATED APPLICATIONS

Not Applicable

### STATEMENT REGARDING FEDERALLY SPONSORED RESEARCH

Not Applicable

### REFERENCE TO APPENDIX

Not Applicable

### BACKGROUND OF THE INVENTION

### Field of the Invention

The present invention relates to the field of wearing apparel including details of garments, more specifically, a trimming. (A41D27/08)

### SUMMARY OF INVENTION

The clothing line with attachable pockets and interchangeable patches is a kit. The clothing line with attachable pockets and interchangeable patches comprises a plurality of garments, one or more pocket structures, a plurality of patches, and a plurality of garment seams. The garment, the pocket, and the patch are defined elsewhere in this disclosure. Each garment seam selected from the plurality of garment seams attaches an individual pocket structure selected from the plurality of pocket structures to an individual garment selected from the plurality of garments. Each individual patch selected from the plurality of patches removably inserts into an individual pocket structure selected from the plurality of pocket structures such that the image applied to the individual patch is visible through the individual pocket structure from the exterior of the individual garment. The clothing line with attachable pockets and interchangeable patches enables the image displayed on any individual patch selected from the plurality of patches to be readily moved and displayed from any first individual garment selected from the plurality of garments to any second individual garment selected from the plurality of garments.

These together with additional objects, features and advantages of the clothing line with attachable pockets and interchangeable patches will be readily apparent to those of ordinary skill in the art upon reading the following detailed description of the presently preferred, but nonetheless illustrative, embodiments when taken in conjunction with the accompanying drawings.

In this respect, before explaining the current embodiments of the clothing line with attachable pockets and interchangeable patches in detail, it is to be understood that the clothing line with attachable pockets and interchangeable patches is not limited in its applications to the details of construction and arrangements of the components set forth in the following description or illustration. Those skilled in the art will appreciate that the concept of this disclosure may be readily utilized as a basis for the design of other structures, methods, and systems for carrying out the several purposes of the clothing line with attachable pockets and interchangeable patches.

It is therefore important that the claims be regarded as including such equivalent construction insofar as they do not depart from the spirit and scope of the clothing line with attachable pockets and interchangeable patches. It is also to be understood that the phraseology and terminology employed herein are for purposes of description and should not be regarded as limiting.

### BRIEF DESCRIPTION OF DRAWINGS

The accompanying drawings, which are included to provide a further understanding of the invention are incorporated in and constitute a part of this specification, illustrate an embodiment of the invention and together with the description serve to explain the principles of the invention. They are meant to be exemplary illustrations provided to enable persons skilled in the art to practice the disclosure and are not intended to limit the scope of the appended claims.

FIG. 1 is a front view of an embodiment of the disclosure.

FIG. 2 is a detail view of an embodiment of the disclosure.

FIG. 3 is an in-use view of an embodiment of the disclosure.

FIG. 4 is an in-use view of an embodiment of the disclosure.

FIG. 5 is an in-use view of an embodiment of the disclosure.

FIG. 6 is a cross-sectional view of an embodiment of the disclosure across 6-6 as shown in FIG. 4.

FIG. 7 is a detail view of an embodiment of the disclosure.

FIG. 8 is a detail view of an embodiment of the disclosure.

### DETAILED DESCRIPTION OF THE EMBODIMENT

The following detailed description is merely exemplary in nature and is not intended to limit the described embodiments of the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the appended claims. Furthermore, there is no intention to be bound by any expressed or implied theory presented in the preceding technical field, background, brief summary or the following detailed description.

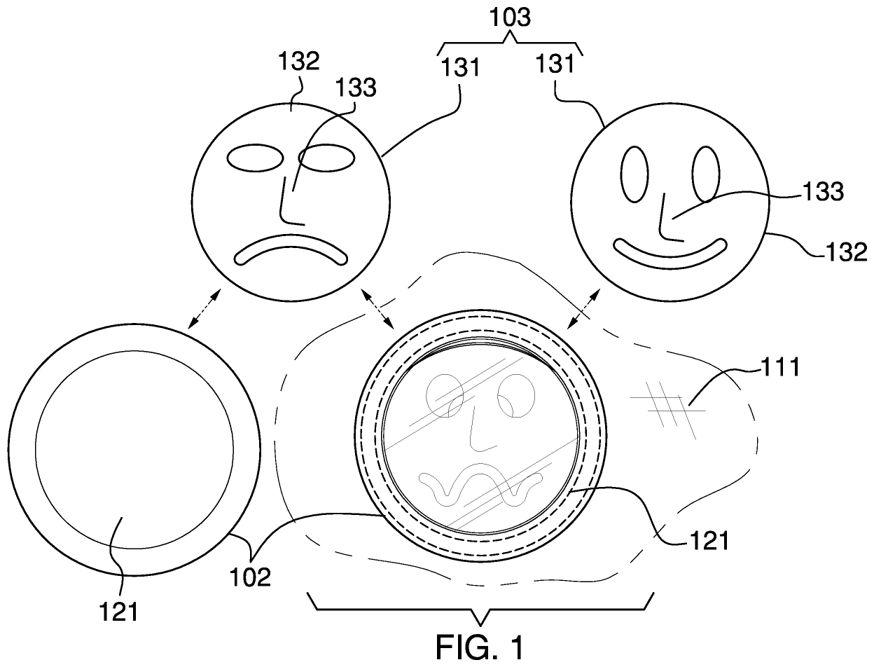

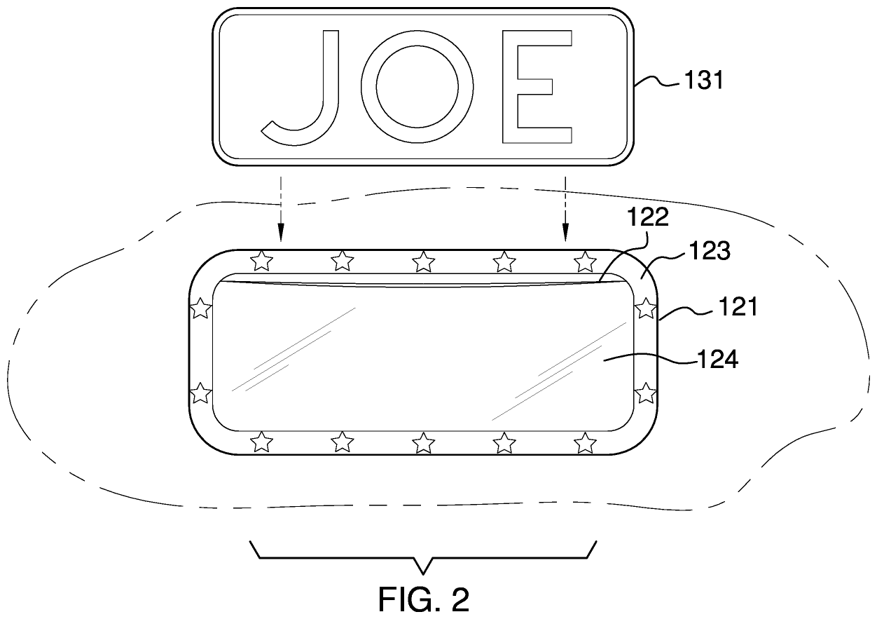

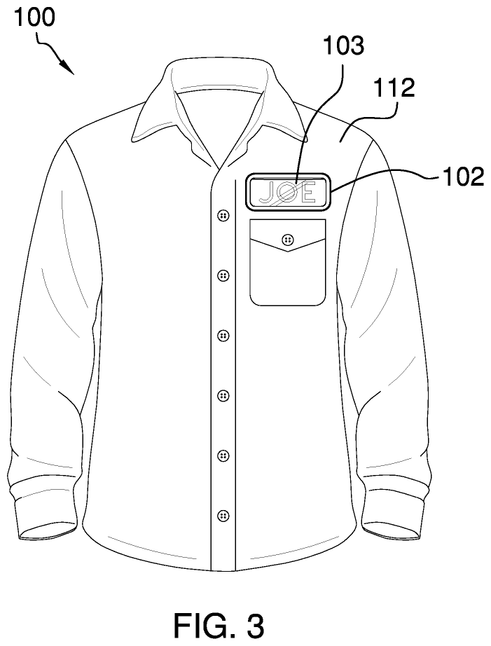

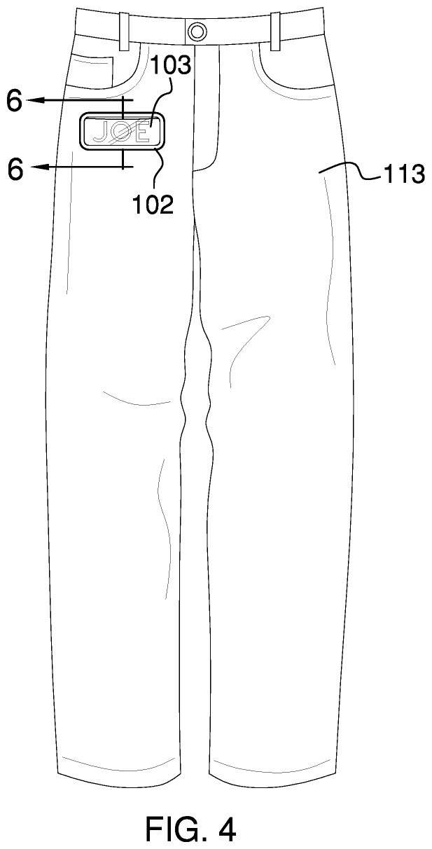

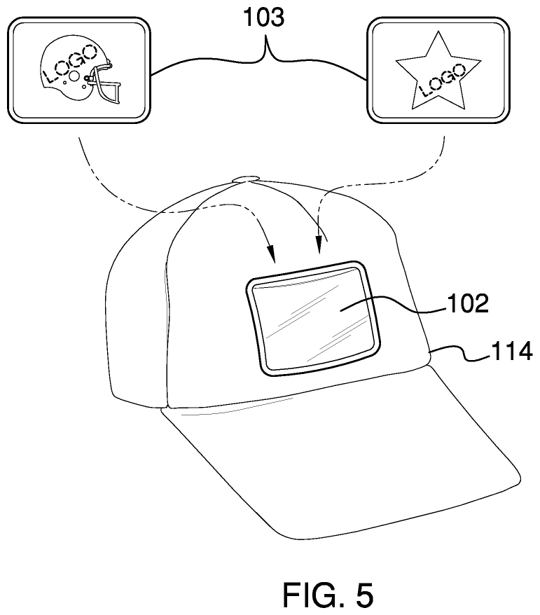

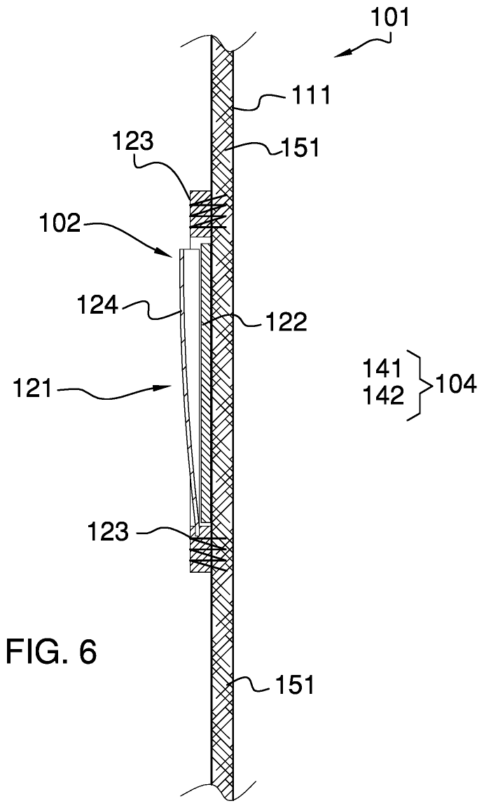

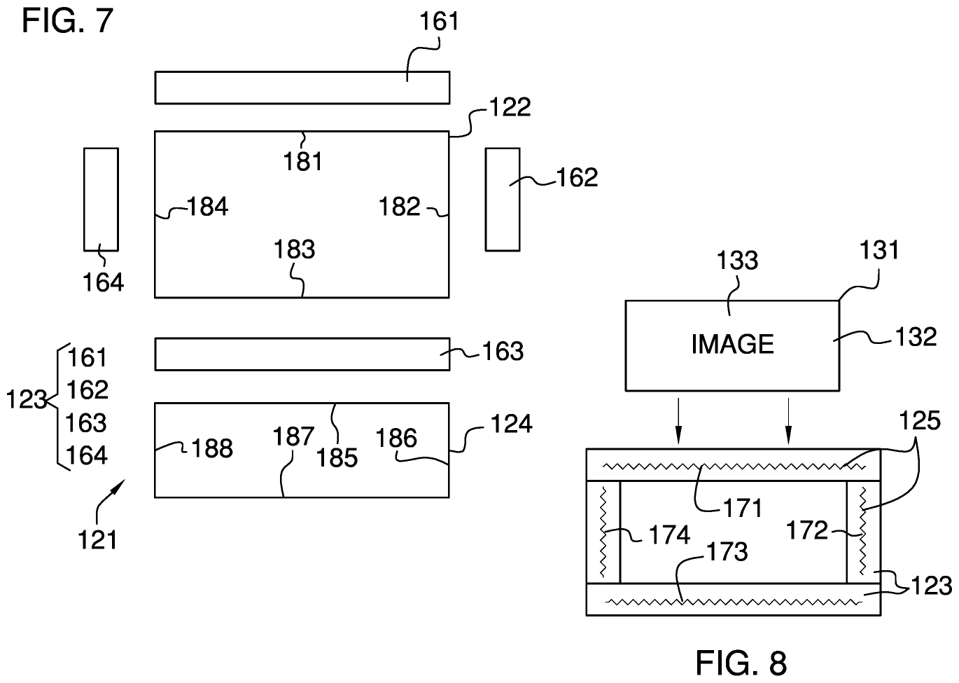

Detailed reference will now be made to one or more potential embodiments of the disclosure, which are illustrated in FIGS. 1 through 8.

The clothing line with attachable pockets and interchangeable patches 100 (hereinafter invention) is a kit. The invention 100 comprises a plurality of garments 101, a plurality of pocket structures 102, a plurality of patches 103, and a plurality of garment seams 104. The garment, the pocket, and the patch are defined elsewhere in this disclosure. Each garment seam selected from the plurality of garment seams 104 attaches an individual pocket structure 121 selected from the plurality of pocket structures 102 to an individual garment 111 selected from the plurality of garments 101. Each individual patch 131 selected from the plurality of patches 103 removably inserts into an individual pocket structure 121 selected from the plurality of pocket structures 102 such that the patch image 133 applied to the individual patch 131 is visible through the individual pocket structure 121 from the exterior of the individual garment 111. The invention 100 enables the patch image 133 displayed on any individual patch 131 selected from the plurality of patches 103 to be readily moved and displayed from any first individual garment 111 selected from the plurality of garments 101 to any second individual garment 111 selected from the plurality of garments 101.

The plurality of garment structures 101 comprises a collection of garments. One or more individual pocket structure selected from the plurality of pocket structures 102 attach to the exterior surface of each individual garment 111 selected from the plurality of garment structures 101. Each individual pocket structure 121 selected from the plurality of pocket structures 102 permanently attaches to an individual garment 111 selected from the plurality of garment structures 101. The plurality of garment structures 101 comprises a collection of individual garments 111.

The individual garment 111 is a garment selected from the plurality of garment structures 101 that has an individual pocket structure 121 selected from the plurality of pocket structures 102 attached to it. The term garment is defined elsewhere in this disclosure. The individual garment 111 is formed from a garment textile 151. The garment textile 151 is a textile used to form the individual garment 111. The textile is defined elsewhere in this disclosure.

Each individual garment 111 is selected from the group consisting of a shirt 112, a pair of pants 113, and a hat 114. The shirt 112 is a garment type that forms an individual garment 111 selected from the plurality of garment structures 101. The shirt 112 is defined elsewhere in this disclosure. The pair of pants 113 is a garment type that forms an individual garment 111 selected from the plurality of garment structures 101. The pair of pants 113 is defined elsewhere in this disclosure. The hat 114 is a garment type that forms an individual garment 111 selected from the plurality of garment structures 101. The hat 114 is defined elsewhere in this disclosure.

The plurality of pocket structures 102 combine to form one or more storage structures on each individual garment 111 selected from the plurality of garment structures 101. Each individual pocket structure 121 selected from the plurality of pocket structures 102 receives an individual patch 131 selected from the plurality of patches 103. Each individual pocket structure 121 selected from the plurality of pocket structures 102 has a transparent structure. Each individual patch 131 removably inserts into its associated individual pocket structure 121 such that the patch image 133 of the individual patch 131 is visibly displayed through the transparent structure of the individual pocket structure 121. Each of the plurality of patches 103 is an individual patch 131 that removably inserts into an individual pocket structure 121 of the plurality of garment structures 101. The plurality of pocket structures 102 comprises a collection of individual pocket structures 121.

Each individual pocket structure 121 is a mechanical structure. Each individual pocket structure 121 attaches to the exterior surface of the garment textile 151 that forms an individual garment 111 selected from the plurality of garment structures 101. The individual pocket structure 121 forms a pocket on the selected individual garment 111. The pocket is defined elsewhere in this disclosure. Each individual pocket structure 121 is sized to receive an individual patch 131 selected from the plurality of patches 103. Each individual pocket structure 121 has a transparent window that allows the patch image 133 of the received individual patch 131 to be viewed from the exterior of the selected individual garment 111. Each individual pocket structure 121 comprises a pocket backing 122, a plurality of gussets 123, a transparent sheeting 124, and a plurality of assembly seams 125.

The pocket backing 122 is a sheeting structure. The pocket backing 122 is a textile based structure. The pocket backing 122 forms a portion of the containment structure formed by the individual garment 111. The pocket backing 122 forms the surface of the individual garment 111 that rests against the garment textile 151 that forms the individual garment 111 to which the pocket backing 122 attaches. The pocket backing 122 forms a portion of the boundary of the containment structure formed by the individual pocket structure 121.

The transparent sheeting 124 is a sheeting structure. The transparent sheeting 124 is a polymer-based sheeting structure. The polymer that forms the transparent sheeting 124 forms a transparent barrier that encloses the individual patch 131 within the individual pocket structure 121. The transparent sheeting 124 forms a portion of the boundary of the containment structure formed by the individual pocket structure 121. The transparent sheeting 124 forms the surface of the individual pocket structure 121 that is opposite to the pocket backing 122. Any individual patch 131 selected from the plurality of patches 103 removably inserts into the individual pocket structure 121 such that the individual patch 131 is sandwiched between the individual pocket structure 121 and the transparent sheeting 124.

The polymer that forms the transparent sheeting 124 is selected from the group consisting of acrylic poly(methyl methacrylic) (CAS 9011-14-7) or polycarbonate (Poly[oxycarbonyloxy-1,4-phenylene (1-methylethylidene)-1,4-phenylene] (CAS 24936-68-3)).

Each individual patch 131 selected from the plurality of patches 103 removably inserts into the individual pocket structure 121 such that the patch image 133 of the individual patch 131 is visible through the transparent sheeting 124. The transparent sheeting 124 is sandwiched between the pocket backing 122 and a subset of gussets selected from the plurality of gussets 123. A subset of assembly seams selected from the plurality of assembly seams 125 are used to secure the transparent sheeting 124 between each gusset contained in the subset of gussets and the pocket backing 122.

The transparent sheeting 124 is geometrically similar to the pocket backing 122. The transparent sheeting 124 is sized such that the span of the length of the perimeter of the transparent sheeting 124 is lesser than the span of the length of the perimeter of the pocket backing 122.

Each of the plurality of gussets 123 is a textile-based webbing. The webbing is defined elsewhere in this disclosure. An assembly seam selected from the plurality of assembly seams 125 attaches each gusset selected from the plurality of gussets 123 to the face of the pocket backing 122 that is distal from the garment textile 151 of the individual garment 111. Each gusset selected from the plurality of gussets 123 attaches to the pocket backing 122 such that the plurality of gussets 123 borders the full perimeter of the pocket backing 122.

Each of the plurality of assembly seams 125 is a seam. Each of the plurality of assembly seams 125 attaches a gusset selected from the plurality of gussets 123 to the pocket backing 122. The plurality of assembly seams 125 attach the plurality of gussets 123 to the pocket backing 122 such that the plurality of gussets 123 form a border around the perimeter of the pocket backing 122. The plurality of assembly seams 125 further attaches the transparent sheeting 124 to the pocket backing 122 such that the transparent sheeting 124 is sandwiched between the pocket backing 122 and a subset of gussets selected from the plurality of gussets 123. In the first potential embodiment of the disclosure, each of the plurality of assembly seams 125 is a sewn seam.

Each of the plurality of patches 103 displays a patch image 133 through the transparent sheeting 124 of the individual pocket structure 121 selected to receive the selected individual patch 131. The removable insertion allows for the interchange of each of the plurality of patches 103 to allow for the exchange of the sentiments presented by the patch image 133 of each individual patch 131. A first individual patch 131 selected from the plurality of patches 103 can be exchanged with a second individual patch 131 selected from the plurality of patches 103. An individual patch 131 selected from the plurality of patches 103 can also be exchanged as a display on a first individual garment 111 selected from the plurality of garment structures 101 to the display on a second individual garment 111 selected from the plurality of garment structures 101. The plurality of patches 103 comprises a collection of individual patch 131.

The individual patch 131 is a sheeting structure. The individual patch 131 is a flexible structure. The individual patch 131 is geometrically similar to the shapes of the pocket backing 122 and the transparent sheeting 124. The individual patch 131 is sized such that the span of the length of the perimeter of the individual patch 131 is lesser than the span of the length of the perimeter of the transparent sheeting 124. The individual patch 131 displays a patch image 133. The individual patch 131 inserts into the individual pocket structure 121 such that the patch image 133 is visible through the transparent sheeting 124. Each individual patch 131 comprises a disk structure 132 and a patch image 133.

The disk structure 132 forms the base sheeting structure of the individual patch 131. The disk structure 132 is a textile based structure. The disk structure 132 is geometrically similar to the shapes of the pocket backing 122 and the transparent sheeting 124. The disk structure 132 is sized such that the span of the length of the perimeter of the disk structure 132 is lesser than the span of the length of the perimeter of the transparent sheeting 124. The disk structure 132 receives and displays the patch image 133.

The patch image 133 is an image displayed on a face of the textile structure formed by the disk structure 132. The patch image 133 displays one or more indicia. Each of the one or more indicia that forms the patch image 133 is selected to indicate a sentiment. The sentiment of the patch image 133 of any first individual patch 131 selected from the plurality of patches 103 differs from the sentiment presented by the patch image 133 of any second individual patch 131 selected from the plurality of patches 103.

Each of the plurality of garment seams 104 is a seam. Each of the plurality of garment seams 104 permanently attaches an individual pocket structure 121 selected from the plurality of pocket structures 102 to the individual garment 111 selected from the garment textile 151. Each selected garment seam attaches the selected individual pocket structure 121 to the exterior surface of the garment textile 151 that forms the individual garment 111. The plurality of garment seams 104 comprises a first garment seam 141 and a second garment seam 142. The first garment seam 141 is a sewn seam that attaches the first gusset 161 and the pocket backing 122 to the garment textile 151 of the individual garment 111. The second garment seam 142 is a sewn seam that attaches the third gusset 163, the pocket backing 122, and the transparent sheeting 124 to the garment textile 151.

In the first potential embodiment of the disclosure, the pocket backing 122 has a rectangular shape. The pocket backing 122 is further defined with a first edge 181, a second edge 182, a third edge 183, and a fourth edge 184. The first edge 181 is the edge of the perimeter of the pocket backing 122 that has the greatest span of length. The second edge 182 is the edge of the perimeter of the pocket backing 122 that has the least span of length. The third edge 183 is the edge of the perimeter of the pocket backing 122 that is distal from the first edge 181. The third edge 183 is parallel to the first edge 181. The fourth edge 184 is the edge of the perimeter of the pocket backing 122 that is distal from the second edge 182. The fourth edge 184 is parallel to the second edge 182. The second edge 182 and the fourth edge 184 are perpendicular to the first edge 181 and the third edge 183.

In the first potential embodiment of the disclosure, the transparent sheeting 124 has a rectangular shape. The transparent sheeting 124 is further defined with a fifth edge 185, a sixth edge 186, a seventh edge 187, and an eighth edge 188. The fifth edge 185 is the edge of the perimeter of the transparent sheeting 124 that has the greatest span of length. The sixth edge 186 is the edge of the perimeter of the transparent sheeting 124 that has the least span of length. The seventh edge 187 is the edge of the perimeter of the transparent sheeting 124 that is distal from the fifth edge 185. The seventh edge 187 is parallel to the fifth edge 185. The eighth edge 188 is the edge of the perimeter of the transparent sheeting 124 that is distal from the sixth edge 186. The eighth edge 188 is parallel to the sixth edge 186. The sixth edge 186 and the eighth edge 188 are perpendicular to the fifth edge 185 and the seventh edge 187.

In the first potential embodiment of the disclosure, the plurality of gussets 123 comprises a first gusset 161, a second gusset 162, a third gusset 163, and a fourth gusset 164.

The first gusset 161 is a webbing with a rectangular shape. The first gusset 161 attaches to the first edge 181 of the pocket backing 122 such that the major axis of the first gusset 161 is parallel to the first edge 181.

The second gusset 162 is a webbing with a rectangular shape. The second gusset 162 attaches to the second edge 182 of the pocket backing 122 such that the major axis of the second gusset 162 is parallel to the second edge 182.

The third gusset 163 is a webbing with a rectangular shape. The third gusset 163 attaches to the third edge 183 of the pocket backing 122 such that the major axis of the third gusset 163 is parallel to the third edge 183.

The fourth gusset 164 is a webbing with a rectangular shape. The fourth gusset 164 attaches to the fourth edge 184 of the pocket backing 122 such that the major axis of the fourth gusset 164 is parallel to the fourth edge 184.

In the first potential embodiment of the disclosure, the plurality of assembly seams 125 comprises a first assembly seam 171, a second assembly seam 172, a third assembly seam 173, and a fourth assembly seam 174.

The first assembly seam 171 is a sewn seam. The first assembly seam 171 attaches the first edge 181 of the pocket backing 122 and the first gusset 161 to the garment textile 151 of the individual garment 111.

The second assembly seam 172 is a sewn seam. The second assembly seam 172 attaches the second edge 182 of the pocket backing 122, the second gusset 162, and the sixth edge 186 of the transparent sheeting 124 to the garment textile 151 of the individual garment 111.

The third assembly seam 173 is a sewn seam. The third assembly seam 173 attaches the third edge 183 of the pocket backing 122, the third gusset 163, and the seventh edge 187 of the transparent sheeting 124 to the garment textile 151 of the individual garment 111.

The fourth assembly seam 174 is a sewn seam. The fourth assembly seam 174 attaches the fourth edge 184 of the pocket backing 122, the fourth gusset 164, and the eighth edge 188 of the transparent sheeting 124 to the garment textile 151 of the individual garment 111.

The plurality of assembly seams 125 secures the transparent sheeting 124 and the pocket backing 122 such that an opening is formed between the transparent sheeting 124 and the pocket backing 122 along the first edge 181 to receive the individual patch 131.

The following definitions were used in this disclosure:

Composite Textile: As used in this disclosure, a composite textile is a multilayer fabric made of two or more joined layers of textile or sheeting materials.

Correspond: As used in this disclosure, the term correspond is used as a comparison between two or more objects wherein one or more properties shared by the two or more objects match, agree, or align within acceptable manufacturing tolerances.

Disk: As used in this disclosure, a disk is a prism-shaped object that is flat in appearance. The disk is formed from two congruent ends that are attached by a lateral face. The sum of the surface areas of two congruent ends of the prism-shaped object that forms the disk is greater than the surface area of the lateral face of the prism-shaped object that forms the disk. In this disclosure, the congruent ends of the prism-shaped structure that forms the disk are referred to as the faces of the disk.

Exterior: As used in this disclosure, the exterior is used as a relational term that implies that an object is not contained within the boundary of a structure or a space.

Garment: As used in this disclosure, a garment is a textile based structure that is used to cover an individual.

Clothes, clothing, and apparel are synonyms for garment. Geometrically Similar: As used in this disclosure, geometrically similar is a term that compares a first object to a second object wherein: 1) the sides of the first object have a one to one correspondence to the sides of the second object; 2) wherein the ratio of the length of each pair of corresponding sides are equal; 3) the angles formed by the first object have a one to one correspondence to the angles of the second object; and, 4) wherein the corresponding angles are equal. The term geometrically identical refers to a situation where the ratio of the length of each pair of corresponding sides equals 1.

Gusset: As used in this disclosure, a gusset is a second textile that attaches to a first textile such that the second textile reinforces the ability of the first textile to handle forces otherwise borne by the first textile.

Image: As used in this disclosure, an image is an optical representation or reproduction of an indicia or of the appearance of something or someone. See indicia sentiment optical character recognition. See Label.

Indicia: As used in this disclosure, the term indicia refers to a set of markings that identify a sentiment.

Interior: As used in this disclosure, the interior is used as a relational term that implies that an object is contained within the boundary of a structure or a space.

Label: As used in this disclosure, a label is a structure that attaches to an object. The label displays an image of an indicia that is visibly displayed by the object. The indicia of the label provides a sentiment about the object to which the label attaches. The term tag is a synonym for a label.

Major and Minor Axes: As used in this disclosure, the major and minor axes refer to a pair of perpendicular axes that are defined within a structure. The length of the major axis is always greater than or equal to the length of the minor axis. The major axis is always the longest diameter of the structure. The major and minor axes intersect at the center of the structure. The major axis is always parallel to the longest edge of a rectangular structure.

One to One: When used in this disclosure, a one to one relationship means that a first element selected from a first set is in some manner connected to only one element of a second set. A one to one correspondence means that the one to one relationship exists both from the first set to the second set and from the second set to the first set. A one to one fashion means that the one to one relationship exists in only one direction. In a one to one correspondence, the first element of the first set is said to be associated to the second element of the second set to which the first element corresponds.

Pants: As used in this disclosure, pants refers to a garment that: 1) covers a portion of a person from the waist to the ankles; 2) comprises two individual sleeves; 3) wherein each individual sleeve covers a body part selected from the group consisting of the left leg of the person and the right leg of the person. Pants are commonly referred to as a pair of pants. Each individual sleeve is commonly referred to as a pant leg. The term shorts refers to paints wherein the span of the length of each individual sleeve is less than the length required to fully cover the legs of the person.

Patch: As used in this disclosure, a patch is a first sheeting structure that is applied to a second sheeting structure for the purpose of: a) repairing damage to the second sheeting structure; or, b) visibly displaying an image formed on the first sheeting structure from the second sheeting structure.

Perimeter: As used in this disclosure, a perimeter is one or more curved or straight lines that bounds an enclosed area on a plane or surface. The perimeter of a circle is commonly referred to as a circumference.

Prism: As used in this disclosure, a prism is a three-dimensional geometric structure wherein: 1) the form factor of two faces of the prism are congruent; and, 2) the two congruent faces are parallel to each other. The two congruent faces are also commonly referred to as the ends of the prism. The surfaces that connect the two congruent faces are called the lateral faces. In this disclosure, when further description is required a prism will be named for the geometric or descriptive name of the form factor of the two congruent faces. If the form factor of the two corresponding faces has no clearly established or well-known geometric or descriptive name, the term irregular prism will be used. The center axis of a prism is defined as a line that joins the center point of the first congruent face of the prism to the center point of the second corresponding congruent face of the prism. The center axis of a prism is otherwise analogous to the center axis of a cylinder. A prism wherein the ends are circles is commonly referred to as a cylinder.

Reinforce: As used in this disclosure, the term reinforce is a verb that refers to the addition of a second object to a first object with the result of improving the ability of the first object to withstand forces that are applied to the first object.

Sandwich: As used in this disclosure, to sandwich means to insert a first disk-shaped structure between a second disk-shaped structure and a third disk-shaped structure to form a composite prism structure. Specifically: a) a first congruent end of the first disk-shaped structure is placed against a first interior congruent end of the second disk-shaped structure; and, b) a second congruent end of the first disk-shaped structure is placed against a second interior congruent end of the third disk-shaped structure. A first exterior congruent end of the second disk-shaped structure forms a firs overall congruent end of the overall composite prism structure described in this definition. A second exterior congruent end of the third disk-shaped structure forms a second overall congruent end of the overall composite prism structure described in this definition. The second overall congruent end of the overall composite prism structure is distal from the first overall congruent end.

Sentiment: As used in this disclosure, a sentiment refers to a symbolic meaning or message that is communicated through the use of an image, potentially including a text based image. See image and optical character recognition.

Sheath: As used in this disclosure, a sheath is a structure that is used to cover an object and from which the object may be inserted and withdrawn.

Sheeting: As used in this disclosure, a sheeting is a material, such as a paper, textile, a plastic, or a metal foil, in the form of a thin flexible layer or layers. The sheeting forms a disk structure. The two surfaces of the sheeting with the greatest surface area are called the faces of the sheeting.

Shirt: As used in this disclosure, a shirt is any garment that is worn on or over the shoulders of a wearer such that a force applied to the item of apparel in a direction of the foot of the wearer will not disrobe the wearer of the garment. A shirt that is adapted for use by a woman is often called a blouse.

Textile: As used in this disclosure, a textile is a material that is woven, knitted, braided or felted. Synonyms in common usage for this definition include fabric and cloth. The two surfaces of the textile with the greatest surface area are called the faces of the textile.

Transparent: As used in this disclosure, transparent refers to a material that allows light to pass through the material without significant scattering such that an object can be clearly seen through the material.

Webbing: As used in this disclosure, a webbing is strong, close woven or knitted fabric that is used for straps or belting. As used in this disclosure, webbing is a fully formed material that is only cut to length for use. Webbing is not formed by cutting broader materials into strips. Webbings have tensile strength but are too flexible to provide compressive strength and are not suitable for use in pushing objects. The shape of a webbing is approximated by a rectangular disk shape. The two surfaces of a webbing with the greatest surface area are called the faces of the webbing.

Withstand: As used in this disclosure, withstand refers to the ability of an object to avoid damage from forces that are applied to the object.

With respect to the above description, it is to be realized that the optimum dimensional relationship for the various components of the invention described above and in FIGS. 1 through 8 include variations in size, materials, shape, form, function, and manner of operation, assembly and use, are deemed readily apparent and obvious to one skilled in the art, and all equivalent relationships to those illustrated in the drawings and described in the specification are intended to be encompassed by the invention.

It shall be noted that those skilled in the art will readily recognize numerous adaptations and modifications which can be made to the various embodiments of the present invention which will result in an improved invention, yet all of which will fall within the spirit and scope of the present invention as defined in the following claims. Accordingly, the invention is to be limited only by the scope of the following claims and their equivalents.

What is claimed is:

1. A garment kit comprising
a plurality of garments, a plurality of pocket structures, a plurality of patches, and a plurality of garment seams;
wherein each garment seam selected from the plurality of garment seams attaches an individual pocket structure selected from the plurality of pocket structures to an individual garment selected from the plurality of garments;
wherein each individual patch selected from the plurality of patches removably inserts into an individual pocket structure selected from the plurality of pocket structures such that the patch image applied to the individual patch is visible through the individual pocket structure from the exterior of the individual garment;
wherein the garment kit enables the patch image displayed on any individual patch selected from the plurality of patches to be readily moved and displayed from any first individual garment selected from the plurality of garments to any second individual garment selected from the plurality of garments.

2. The garment kit according to claim 1
wherein the plurality of garment structures comprises a collection of garments;
wherein one or more individual pocket structure selected from the plurality of pocket structures attach to the exterior surface of each individual garment selected from the plurality of garment structures;
wherein each individual pocket structure selected from the plurality of pocket structures permanently attaches to an individual garment selected from the plurality of garment structures.

3. The garment kit according to claim 2
wherein the plurality of garment structures comprises a collection of individual garments;
wherein the individual garment is a garment selected from the plurality of garment structures that has an individual pocket structure selected from the plurality of pocket structures attached to it;
wherein the individual garment is formed from a garment textile.

4. The garment kit according to claim 3 wherein each individual garment is selected from the group consisting of a shirt, a pair of pants, and a hat.

5. The garment kit according to claim 4
wherein the plurality of pocket structures combine to form one or more storage structures on each individual garment selected from the plurality of garment structures;
wherein each of the plurality of patches is an individual patch that removably inserts into an individual pocket structure of the plurality of garment structures;
wherein each individual pocket structure selected from the plurality of pocket structures has a transparent structure;
wherein each individual patch removably inserts into its associated individual pocket structure such that the patch image of the individual patch is visibly displayed through the transparent structure of the individual pocket structure.

6. The garment kit according to claim 5
wherein the plurality of pocket structures comprises a collection of individual pocket structures;
wherein each individual pocket structure is a mechanical structure;
wherein each individual pocket structure attaches to the exterior surface of the garment textile that forms an individual garment selected from the plurality of garment structures;
wherein the individual pocket structure forms a pocket on the selected individual garment;
wherein each individual pocket structure is sized to receive an individual patch selected from the plurality of patches;
wherein each individual pocket structure has a transparent window that allows the patch image of the received individual patch to be viewed from the exterior of the selected individual garment.

7. The garment kit according to claim 6
wherein each of the plurality of patches displays a patch image through the transparent sheeting of the individual pocket structure selected to receive the selected individual patch;
wherein the removable insertion allows for the interchange of each of the plurality of patches to allow for the exchange of the sentiments presented by the patch image of each individual patch;
wherein a first individual patch selected from the plurality of patches is exchanged with a second individual patch selected from the plurality of patches;
wherein an individual patch selected from the plurality of patches is exchanged as a display on a first individual garment selected from the plurality of garment structures to the display on a second individual garment selected from the plurality of garment structures.

8. The garment kit according to claim 7
wherein each individual pocket structure comprises a pocket backing, a plurality of gussets, a transparent sheeting, and a plurality of assembly seams;
wherein the pocket backing forms a portion of the boundary of the containment structure formed by the individual pocket structure;
wherein the transparent sheeting forms a portion of the boundary of the containment structure formed by the individual pocket structure;
wherein each of the plurality of assembly seams attaches a gusset selected from the plurality of gussets to the pocket backing;
wherein an assembly seam selected from the plurality of assembly seams attaches each gusset selected from the plurality of gussets to the face of the pocket backing that is distal from the garment textile of the individual garment;
wherein a subset of assembly seams selected from the plurality of assembly seams are used to secure the transparent sheeting between each gusset contained in the subset of gussets and the pocket backing.

9. The garment kit according to claim 8
wherein the pocket backing is a sheeting structure;
wherein the pocket backing is a textile based structure;
wherein the pocket backing forms the surface of the individual garment that rests against the garment textile that forms the individual garment to which the pocket backing attaches.

10. The garment kit according to claim 9
wherein the transparent sheeting is a sheeting structure;
wherein the transparent sheeting is a polymer-based sheeting structure;
wherein the polymer that forms the transparent sheeting forms a transparent barrier that encloses the individual patch within the individual pocket structure;
wherein the transparent sheeting forms the surface of the individual pocket structure that is opposite to the pocket backing;
wherein any individual patch selected from the plurality of patches removably inserts into the individual pocket structure such that the individual patch is sandwiched between the individual pocket structure and the transparent sheeting.

11. The garment kit according to claim 10
wherein the transparent sheeting is geometrically similar to the pocket backing;
wherein the transparent sheeting is sized such that the span of the length of the perimeter of the transparent sheeting is lesser than the span of the length of the perimeter of the pocket backing.

12. The garment kit according to claim 11
wherein each of the plurality of gussets is a textile-based webbing;
wherein each gusset selected from the plurality of gussets attaches to the pocket backing such that the plurality of gussets borders the full perimeter of the pocket backing.

13. The garment kit according to claim 12
wherein each of the plurality of assembly seams is a seam;
wherein the plurality of assembly seams attach the plurality of gussets to the pocket backing such that the plurality of gussets form a border around the perimeter of the pocket backing;
wherein the plurality of assembly seams further attaches the transparent sheeting to the pocket backing such that the transparent sheeting is sandwiched between the pocket backing and a subset of gussets selected from the plurality of gussets.

14. The garment kit according to claim 13
wherein the plurality of patches comprises a collection of individual patch;
wherein the individual patch is a sheeting structure;
wherein the individual patch is a flexible structure;
wherein the individual patch is geometrically similar to the shapes of the pocket backing and the transparent sheeting;
wherein the individual patch is sized such that the span of the length of the perimeter of the individual patch is lesser than the span of the length of the perimeter of the transparent sheeting;
wherein the individual patch displays a patch image;
wherein the individual patch inserts into the individual pocket structure such that the patch image is visible through the transparent sheeting.

15. The garment kit according to claim 14
wherein each individual patch comprises a disk structure and a patch image;
wherein the disk structure receives and displays the patch image.

16. The garment kit according to claim 16
wherein the disk structure forms the base sheeting structure of the individual patch;
wherein the disk structure is a textile based structure;
wherein the disk structure is geometrically similar to the shapes of the pocket backing and the transparent sheeting;
wherein the disk structure is sized such that the span of the length of the perimeter of the disk structure is lesser than the span of the length of the perimeter of the transparent sheeting.

17. The garment kit according to claim 16
wherein the patch image is an image displayed on a face of the textile structure formed by the disk structure;
wherein the patch image displays one or more indicia;
wherein each of the one or more indicia that forms the patch image is selected to indicate a sentiment;
wherein the sentiment of the patch image of any first individual patch selected from the plurality of patches differs from the sentiment presented by the patch image of any second individual patch selected from the plurality of patches.

18. The garment kit according to claim 17
wherein each of the plurality of garment seams is a seam;
wherein each of the plurality of garment seams permanently attaches an individual pocket structure selected from the plurality of pocket structures to the individual garment selected from the garment textile;
wherein each selected garment seam attaches the selected individual pocket structure to the exterior surface of the garment textile that forms the individual garment.

19. The garment kit according to claim 18
wherein the pocket backing has a rectangular shape;
wherein the pocket backing is further defined with a first edge, a second edge, a third edge, and a fourth edge;
wherein the first edge is the edge of the perimeter of the pocket backing that has the greatest span of length;
wherein the second edge is the edge of the perimeter of the pocket backing that has the least span of length;
wherein the third edge is the edge of the perimeter of the pocket backing that is distal from the first edge;
wherein the third edge is parallel to the first edge;
wherein the fourth edge is the edge of the perimeter of the pocket backing that is distal from the second edge;
wherein the fourth edge is parallel to the second edge;
wherein the second edge and the fourth edge are perpendicular to the first edge and the third edge;
wherein in the first potential embodiment of the disclosure, the transparent sheeting has a rectangular shape;
wherein the transparent sheeting is further defined with a fifth edge, a sixth edge, a seventh edge, and an eighth edge;
wherein the fifth edge is the edge of the perimeter of the transparent sheeting that has the greatest span of length;
wherein the sixth edge is the edge of the perimeter of the transparent sheeting that has the least span of length;
wherein the seventh edge is the edge of the perimeter of the transparent sheeting that is distal from the fifth edge;
wherein the seventh edge is parallel to the fifth edge;
wherein the eighth edge is the edge of the perimeter of the transparent sheeting that is distal from the sixth edge;
wherein the eighth edge is parallel to the sixth edge;
wherein the sixth edge and the eighth edge are perpendicular to the fifth edge and the seventh edge;
wherein in the first potential embodiment of the disclosure, the plurality of gussets comprises a first gusset, a second gusset, a third gusset, and a fourth gusset;
wherein the first gusset is a webbing with a rectangular shape;
wherein the first gusset attaches to the first edge of the pocket backing such that the major axis of the first gusset is parallel to the first edge;
wherein the second gusset is a webbing with a rectangular shape;
wherein the second gusset attaches to the second edge of the pocket backing such that the major axis of the second gusset is parallel to the second edge;
wherein the third gusset is a webbing with a rectangular shape;
wherein the third gusset attaches to the third edge of the pocket backing such that the major axis of the third gusset is parallel to the third edge;
wherein the fourth gusset is a webbing with a rectangular shape;
wherein the fourth gusset attaches to the fourth edge of the pocket backing such that the major axis of the fourth gusset is parallel to the fourth edge;
wherein in the first potential embodiment of the disclosure, the plurality of assembly seams comprises a first assembly seam, a second assembly seam, a third assembly seam, and a fourth assembly seam;
wherein the first assembly seam is a sewn seam;
wherein the first assembly seam attaches the first edge of the pocket backing and the first gusset to the garment textile of the individual garment;
wherein the second assembly seam is a sewn seam;
wherein the second assembly seam attaches the second edge of the pocket backing, the second gusset, and the sixth edge of the transparent sheeting to the garment textile of the individual garment;
wherein the third assembly seam is a sewn seam;
wherein the third assembly seam attaches the third edge of the pocket backing, the third gusset, and the seventh edge of the transparent sheeting to the garment textile of the individual garment;
wherein the fourth assembly seam is a sewn seam;
wherein the fourth assembly seam attaches the fourth edge of the pocket backing, the fourth gusset, and the eighth edge of the transparent sheeting to the garment textile of the individual garment;
wherein the plurality of assembly seams secures the transparent sheeting and the pocket backing such that an opening is formed between the transparent sheeting and the pocket backing along the first edge to receive the individual patch.

20. The garment kit according to claim 19
wherein the plurality of garment seams comprises a first garment seam and a second garment seam;
wherein the first garment seam is a sewn seam that attaches the first gusset and the pocket backing to the garment textile of the individual garment;
wherein the second garment seam is a sewn seam that attaches the third gusset, the pocket backing, and the transparent sheeting to the garment textile.
